(19) United States
(12) Patent Application Publication
(10) Pub. No.: US 2006/0109529 A1
(43) Pub. Date: May 25, 2006

(54) Image recording apparatus

(75) Inventor: Yohichi Shimazawa, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/282,447

(22) Filed: Nov. 17, 2005

(30) Foreign Application Priority Data
Nov. 19, 2004 (JP) 2004-336420

(51) Int. Cl. H04N 1/46

(52) U.S. Cl. 358/540

(57) ABSTRACT

An image recording apparatus for receiving image data and recording an image on a sheet based on the received image data includes storage means for storing a plurality of pieces of image data composed of a plurality of pixels and different in the ratio of pixels having a predetermined pixel value, selecting means for selecting image data to be combined with the received image data from the image data stored in the storage means, and means for combining the image data selected by the selecting means with the received image data, and records an image on a sheet based on the resulting composite image data.

### CROSS-REFERENCE TO RELATED APPLICATION

This non-provisional application claims priority under 35 U.S.C. § 119(a) on Patent Application No. 2004-336420 filed in Japan on Nov. 19, 2004, the entire contents of which are hereby incorporated by reference.

### BACKGROUND OF THE INVENTION

1. Field of the Invention

The present invention relates to an image recording apparatus capable of adding a plurality of types of specific patterns.

2. Description of Related Art

In recent years, with an improvement in the performance of color copying machines, there is an increasing demand for image processors capable of preventing counterfeiting of, for example, banknotes, securities, important documents and classified papers.

As a copy preventing technique for a conventional copying machine, there was a proposed technique that compares image data obtained by scanning an image recorded on recording paper such as a document by an image scanning apparatus with image data about a specific image that is to be protected from being copied and is pre-stored in a copying machine, determines whether or not to perform image formation of the scanned image, and stops image formation or forms an image different from the scanned image when image formation should not be performed (see, for example, Japanese Patent No. 2614369 and Japanese Patent Application Laid-Open No. 2001-103278).

For example, Japanese Patent No. 2614369 proposes a technique of tracking copies of banknotes by adding a specific pattern, such as identification information unique to the machine, in a color that is hard to be recognized by the human's eye during printing upon detection of specific information such as a banknote from input means.

On the other hand, Japanese Patent Application Laid-Open No. 2001-103278 proposes a technique for facilitating tracking of forged copies by forming a satisfactory image without interference between the original additional information and newly added information when specific information indicating a forged copy is present in addition to the original image information.

However, the image processors disclosed in the above-mentioned patent documents embed information unique to the machine into copies when they detect specific image information embedded in a banknote, security or important document, and track the copying machine used for making forged copies, or the installation location of the copying machine.

In other words, although they are similar in terms of adding new information to copies, they are intended to recognize predetermined specific images, such as banknotes, and are not intended to improve the detection method of specific images. Moreover, the information added to image information is information for tracking forged copies and does not show the degree of importance of an image set by an operator.

### BRIEF SUMMARY OF THE INVENTION

The present invention has been made with the aim of solving the above problems, and it is an object of the invention to provide an image recording apparatus capable of changing an image to be added according to the importance of a document, and capable of adding an image that is easily detectable when secondary copying the added image.

An image recording apparatus according to the present invention is an image recording apparatus for receiving image data and recording an image on a sheet based on the received image data, and characterized by comprising: storage means for storing a plurality of pieces of image data composed of a plurality of pixels and different in a ratio of pixels having a predetermined pixel value; selecting means for selecting image data to be combined with received image data from the image data stored in the storage means; and means for combining the image data selected by the selecting means with the received image data, wherein an image is recorded on a sheet based on the resulting composite image data.

According to this invention, the image recording apparatus comprises storage means for storing a plurality of pieces of image data different in the ratio of pixels having a predetermined pixel value, selects image data to be combined with the received image data from the image data stored in the storage means, and records an image on a sheet after combining the selecting image data. It is therefore possible to change image data to be combined, according to the importance, confidentiality or other factor of a document. Moreover, since the resulting composite images are images constructed with different ratios of the pixels having the predetermined pixel value, they are detectable by just examining the distribution of the number of pixels without extracting the features of the image during detection.

An image recording apparatus according to the present invention is characterized by comprising: means for receiving information about the ratio of the pixels; means for changing the image data stored in the above-mentioned means, based on the information received by the above-mentioned means; and means for storing the changed image data in the storage means.

According to this invention, information about the ratio of the pixels is received, and then the image data stored in the storage means is changed based on the received information. Therefore, when there is a need to change image data to be combined, only the information about the ratio of the pixels may be inputted.

An image recording apparatus according to the present invention is characterized by comprising means for receiving information about importance of received image data, wherein image data to be combined is selected based on the received information.

According to this invention, the image recording apparatus comprises means for receiving information about importance of the received image, and selects image data to be combined, based on the received information. Thus, image data according to the importance of a document is selected, and a composite image including the selected image data is recorded on a sheet.

An image recording apparatus according to the present invention is characterized by comprising means for receiving information about confidentiality of received image data, wherein image data to be combined is selected based on the received information.

According to this invention, the image recording apparatus comprises means for receiving information about confidentiality of received image data, and selects image data to be combined, based on the received information. Thus, image data according to the confidentiality of a document is selected, and a composite image including the selected image data is recorded on a sheet.

An image recording apparatus according to the present invention is characterized by comprising: scanning means for scanning an image recorded on a sheet; means for extracting an area from the image scanned by the scanning means; means for calculating a ratio of pixels having a predetermined pixel value to pixels constituting the extracted area; and means for detecting a type of an image included in the area, based on the calculated ratio of pixels.

According to this invention, the ratio of pixels having a predetermined pixel value to pixels constituting the extracted area is calculated, and then the type of an image included in the area is detected based on the calculated ratio of pixels. Therefore, it is not necessary to extract features of the image when detecting the type of the image included in the extracted area, and the type is discriminated by counting the number of pixels having the predetermined pixel value.

An image recording apparatus according to the present invention is characterized by comprising a table defining a relation between a type of an image to be detected and the ratio of pixels having the pixel value in the area including the image, wherein the type of the image is detected by referring to the relation defined in the table.

According to this invention, the image recording apparatus comprises a table defining the relation between a type of an image to be detected and the ratio of pixels having the pixel value in the area including the image, and detects the type of the image by referring to the table. Therefore, the type of the image included in the extracted area is discriminated by counting the number of pixels having the predetermined pixel value.

An image recording apparatus according to the present invention is characterized by comprising: means for determining whether or not the detected type of the image is a predetermined type; and means for prohibiting recording of the image scanned by the scanning means on a sheet when a determination is made that the detected type is the predetermined type.

According to this invention, since recording of the scanned image on a sheet is prohibited when the detected image is determined to be a predetermined type, it is possible to prohibit copying of a document including a predetermined pattern.

An image recording apparatus according to the present invention is characterized by comprising: means for determining whether or not the detected type of the image is a predetermined type; means for receiving information about a user when a determination is made that the detected type is the predetermined type; means for authenticating the user based on the received information; and means for prohibiting recording of the image scanned by the scanning means on a sheet when a determination is made that the user cannot be authenticated by the above-mentioned means.

According to this invention, when the detected image is determined to be a predetermined type, a determination as to whether or not to allow recording of the image is made after authenticating a user. It is therefore possible to prohibit people other than a predetermined user from copying a document.

According to the present invention, the image recording apparatus comprises storage means for storing a plurality of pieces of image data different in the ratio of pixels having a predetermined pixel value, selects image data to be combined with received image data from the image data stored in the storage means, and records an image on a sheet after combining the selecting image data. Therefore, image data to be combined can be changed according to the importance, confidentiality or other factor of a document. Moreover, since the resulting composite images are images constructed with different ratios of the pixels having the predetermined pixel value, they can be detected by just examining the distribution of the number of pixels without extracting the features of the image during detection.

According to the present invention, information about the ratio of the pixels is received, and then the image data stored in the storage means is changed based on the received information. Therefore, when there is a need to change image data to be combined, image data to be combined can be created by inputting only the information about the ratio of the pixels.

According to the present invention, the image recording apparatus comprises means for receiving information about importance of the received image, and selects image data to be combined, based on the received information. Thus, image data according to the importance of a document is selected, and a composite image including the selected image data can be recorded on a sheet.

According to the present invention, the image recording apparatus comprises means for receiving information about confidentiality of received image data, and selects image data to be combined, based on the received information. Thus, image data according to the confidentiality of a document is selected, and a composite image including the selected image data can be recorded on a sheet.

According to the present invention, the ratio of pixels having a predetermined pixel value to pixels constituting an extracted area is calculated, and then the type of an image included in the area is detected based on the calculated ratio of pixels. Therefore, it is not necessary to extract features of the image when detecting the type of the image included in the extracted area, and it is possible to discriminate the type by counting the number of pixels having the predetermined pixel value.

According to the present invention, the image recording apparatus comprises a table defining the relation between a type of an image to be detected and the ratio of pixels having the pixel value in the area including the image, and detects the type of the image by referring to the table. It is therefore possible to discriminate the type of the image included in the extracted area by counting the number of pixels having the predetermined pixel value.

According to the present invention, when the detected image is determined to be a predetermined type, recording of the scanned image on a sheet is prohibited. It is therefore possible to prohibit copying of a document including a predetermined pattern.

According to the present invention, when the detected image is determined to be a predetermined type, a determination as to whether or not to allow recording of the image is made after authenticating a user. It is therefore possible to prohibit people other than a predetermined user from copying a document.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view for explaining the structure of an image recording system including a digital multi-function machine of this embodiment;

FIG. 2 is a block diagram showing the internal structure of the digital multi-function machine;

FIGS. 3A and 3B are schematic views showing one example of an operating panel;

FIGS. 4A to 4C are explanatory views for explaining the relationship between the set importance degrees and specific patterns to be added;

FIGS. 5A and 5B are schematic views showing structures of specific patterns;

FIGS. 6A and 6B are explanatory views for explaining the distribution of the number of pixels in specific patterns;

FIGS. 7A and 7B are schematic views showing other structures of specific patterns;

FIG. 8 is a flowchart for explaining the processing steps for recording a specific pattern on paper;

FIG. 9 is an explanatory view for explaining the state when scanning a document;

FIGS. 10A and 10B are explanatory views for explaining the content of processing performed when detecting boundary lines;

FIGS. 11A and 11B are explanatory views for explaining the relationship between an example of dividing a detection area and the distribution of the number of pixels; and

FIG. 12 is a flowchart for explaining the processing step for copying a document.

### DETALIED DESCRIPTION OF THE INVENTION

The following description will specifically explain a digital multi-function machine as an application example of an image recording apparatus of the present invention, based on the drawings illustrating an embodiment thereof.

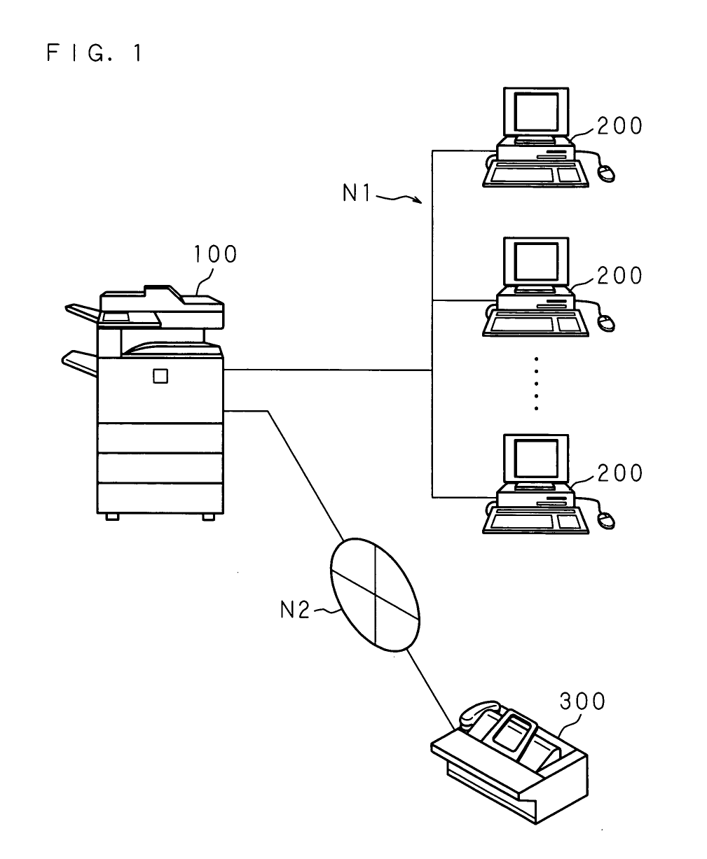

FIG. 1 is a schematic view showing the structure of an image recording system of the present invention, including a digital multi-function machine of this embodiment. In FIG. 1, 100 represents a digital multi-function machine of this embodiment to which information processors 200, 200, . . . , 200 such as a personal computer and a work station, are connected through a communication network N1, and an external facsimile machine 300 is connected through a facsimile communication network N2.

A driver program (printer driver) for using the digital multi-function machine 100 through the communication network N1 is preinstalled in the information processor 200 so that an output process is executed by generating print data and transmitting the generated print data to the digital multi-function machine 100 by the printer driver. When the digital multi-function machine 100 receives the print data transmitted from the information processor 200, it generates image data for output according to the print data, and records an image on a sheet of paper, OHP film or the like (hereinafter simply referred to as paper), based on the generated image data.

The facsimile machine 300 is capable of transmitting coded facsimile data to the digital multi-function machine 100 through the facsimile communication network N2. When the digital multi-function machine 100 receives facsimile data transmitted from the facsimile machine 300, it decodes the facsimile data to obtain image data for output. Then, the digital multi-function machine 100 records an image on paper based on the obtained image data.

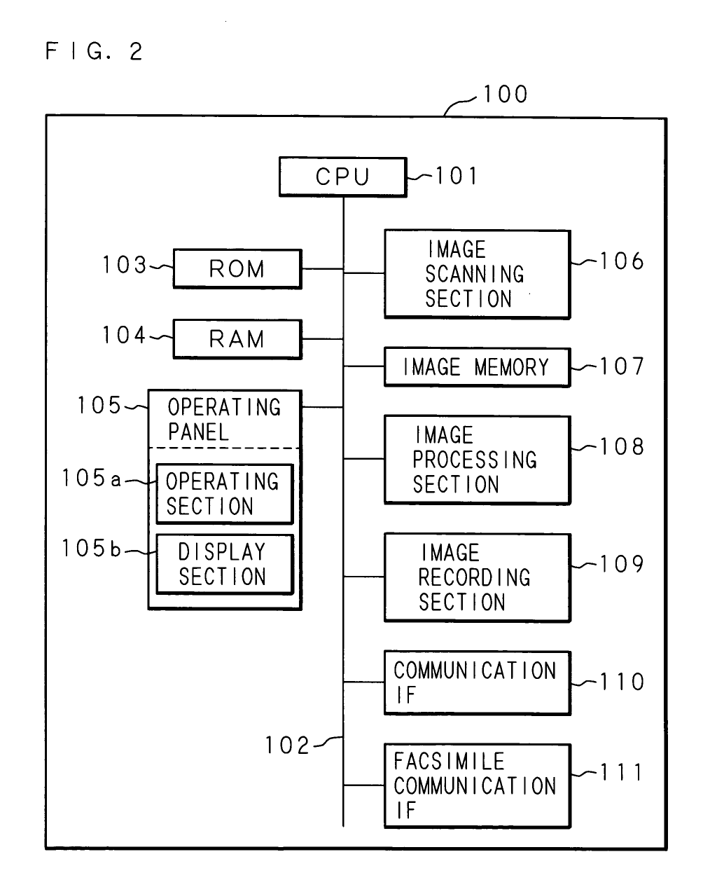

Moreover, the digital multi-function machine 100 has a copy function in addition to the above-mentioned print function and facsimile function. In other words, the digital multi-function machine 100 incorporates an image scanning unit 106 (see FIG. 2) comprising a CCD line sensor (CCD: Charge Coupled Device), optically scans an image recorded on a document, and records an image on paper based on image data obtained by the image scanning unit 106.

The digital multi-function machine 100 of this embodiment selects a pattern to be combined, according to the degree of importance of image data inputted from the outside or image data scanned through the image scanning unit 106, and records an image on paper after combining the selected pattern.

FIG. 2 is a block diagram showing the internal structure of the digital multi-function machine 100. The digital multi-function machine 100 comprises a CPU 101. By loading a control program stored in a ROM 103 into a RAM 104 and executing it, the CPU 101 controls various hardware devices connected to a bus 102 to operate as an image recording apparatus of the present invention.

The following description will explain the structures of various hardware devices connected to the bus 102. An operating panel 105 is composed of an operating section 105a for receiving an operating instruction from a user, and a display section 105b for displaying information to be given to the user. The operating section 105a comprises various hardware keys, and receives a function switching operation and settings about the number of prints, the density of recording an image, etc. The display section 105b comprises a liquid crystal display, an LED display or the like, and displays the operation state of the digital multi-function machine 100 and setting values inputted through the operating section 105a. Further, touch-panel type software keys are arranged in a part of the display section 105b to receive the user's selecting operation.

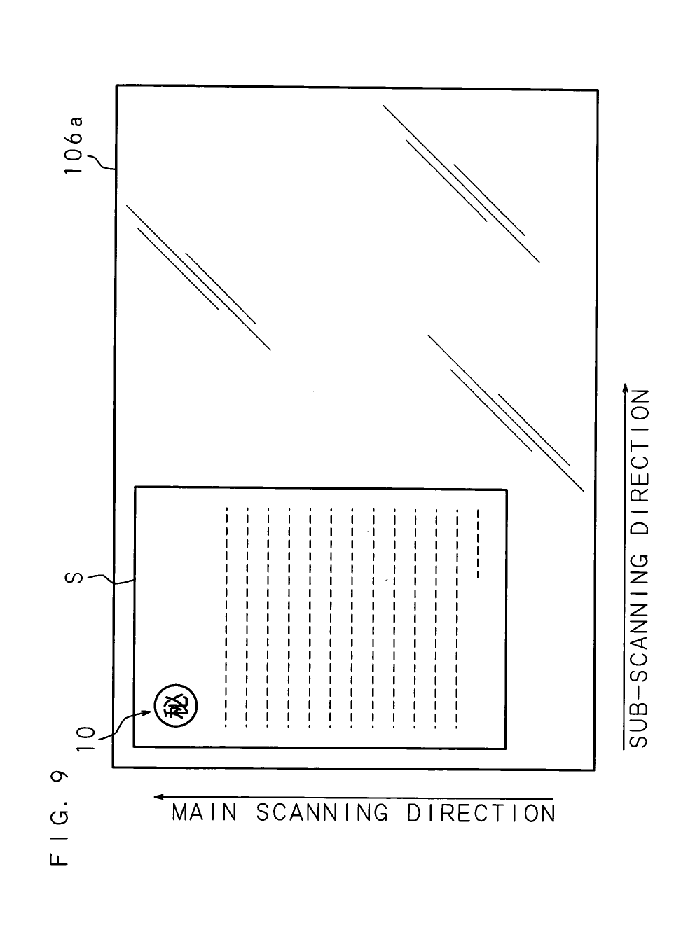

The image scanning unit 106 comprises a document mounting 106a made of glass for mounting a document (see FIG. 9), a light source for irradiating light on a document to be scanned, a CCD line sensor for optically scanning an image, and an AD converter for converting an analog image signal outputted by the CCD line sensor into a digital signal. In the image scanning unit 106, digital image data is obtained by focusing an image of a document set at a predetermined scanning position on the document mounting 106a onto the CCD line sensor, converting an analog signal outputted by the CCD line sensor into a digital signal, and correcting the obtained digital signal with respect to the light distribution characteristic of the light source and the irregularity of the sensitivity of the CCD line sensor when scanning the document. This image data is composed of a plurality of pixels, and each pixel has 256 gradations for each of RGB colors and thus has 16777216 gradations (color scales).

An image memory 107 is a volatile semiconductor memory, and temperately stores image data outputted from the image scanning unit 106, and image data outputted from a later-described communication IF 110 and facsimile communication IF 111. The image memory 107 stores these image data on a page-by-page basis, and transfers the image data to an image processing section 108, or an image recording section 109, according to an instruction from the CPU 101.

The image processing section 108 comprises a memory and an arithmetic circuit (not shown), adds a specific mark (hereinafter referred to as a specific pattern) based on the degree of importance of image data transferred from the image scanning unit 106 via the image memory 107, and determines whether or not a specific pattern is included. Therefore, the image processing section 108 performs the process of selecting a specific pattern to be added based on the degree of importance of the transferred image data, the process of combining the selected specific pattern with image data for output, and the process of recording an image on paper based on the resulting composite image data (output process). Moreover, in order to determine whether or not a specific pattern is included, the image processing section 108 performs the process of binarizing the transferred image data, the process of extracting an area as a candidate of an object to be detected (hereinafter referred to as a detection area) based on the binarized image data, and the process of determining the type of a mark included in the detection area. In this embodiment, it is possible to add and detect two types of specific patterns (hereinafter referred to as the first specific pattern and the second specific pattern). Note that the respective processes executed by the image processing section 108 will be described in detail later.

The image recording section 109 records an image on paper, based on image data transferred from the image memory 107. Therefore, the image recording section 109 comprises a charger for charging a photoconductive drum to a predetermined potential, a laser write device for creating an electrostatic latent image on the photoconductive drum by emitting laser light according to image data received from outside, a developing device for visualizing the image by supplying toner to the electrostatic latent image formed on the photoconductive drum surface, and a transfer device (not shown) for transferring the toner image formed on the photoconductive drum surface onto paper, and records an image desired by the user on paper by an electrophotographic method. Note that it may be possible to record an image by an ink jet method, a thermal transfer method, a sublimation method, etc. as well as the electrophotographic method using a laser write device.

The communication IF 110 has a communication interface conforming to the communication standards of the communication network N1, and is capable of connecting the information processor 200 through the communication network N1. The communication IF 110 receives print data transmitted from the connected information processor 200, and transmits information to be given to the information processor 200. The communication IF 110 controls such transmission and reception of various types of data. Moreover, the communication IF 110 has a function to receive print data transmitted from the information processor 200 and develops the print data into image data for output, and outputs the image data obtained by development to the image memory 107.

The facsimile communication IF 111 comprises a circuit terminating device for connecting an external facsimile machine 300, and enables transmission and reception of facsimile data through the facsimile communication network N2. Therefore, the facsimile communication IF 111 comprises a decoding circuit for decoding the received facsimile data, and an encoding circuit for encoding facsimile data to be transmitted. The facsimile communication IF 111 executes such transmission and reception of facsimile data, and the encoding process and the decoding process. Note that the image data for output obtained by decrypting the received facsimile data is outputted to the image memory 107.

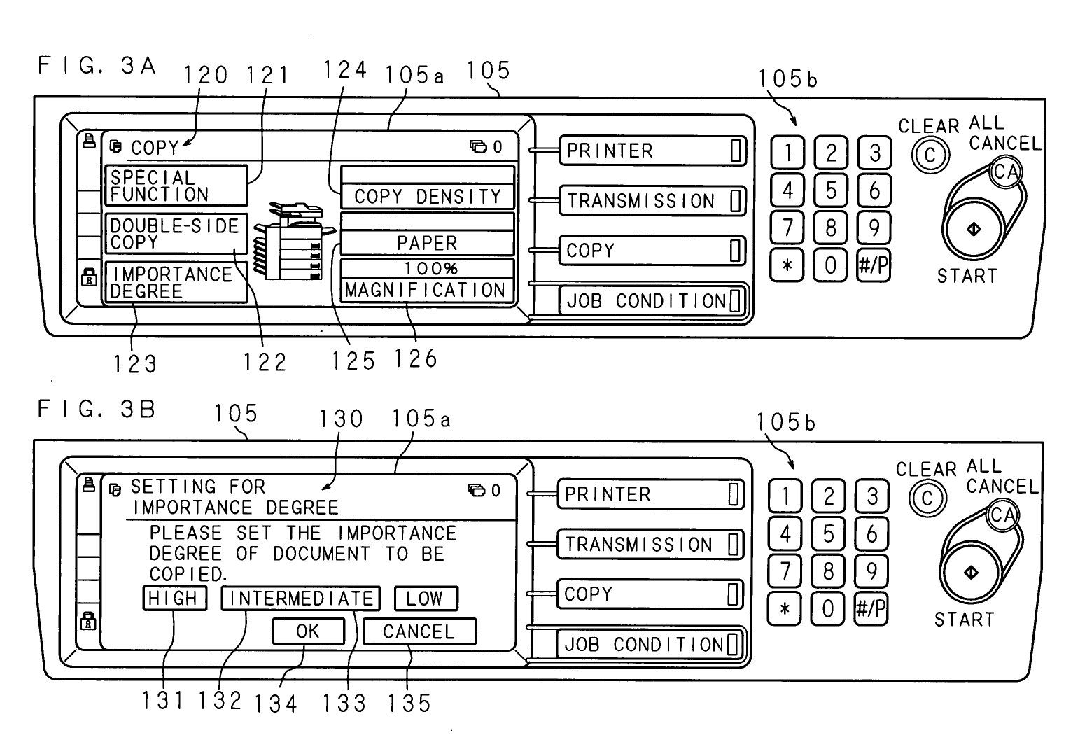

The following description will specifically explain the process of adding a specific pattern in a copying process. The degree of importance of a document to be copied is set through the operating panel 105. FIGS. 3A and 3B are schematic views showing one example of the operating panel 105. The operating panel 105 comprises the operating section 105a including various hardware keys, and a display section 105b composed of a liquid crystal display.

The hardware keys arranged in the operating section 105a include a function switching key for switching functions such as a printer function, an image data transmission function and a copy function, the ten-keys for inputting numerical values concerning the number of copies, destination, etc., the “Clear” key for clearing the inputted value, the “Cancel All” key for canceling all the inputted settings, and the “Start” key for giving an instruction to start scanning a document.

In the state of waiting for an instruction to start scanning a document, an initial screen 120 as shown in FIG. 3A is displayed on the display section 105b. In this initial screen 120, a special function key 121, a double-side copy key 122, an importance degree setting key 123, a copy density setting key 124, a paper setting key 125 and a magnification setting key 126 are arranged as software keys to allow a user to make detailed settings for a copying process by pressing these keys.

Among these keys, when the importance degree setting key 123 is pressed, the screen shown on the display section 105b changes to an importance degree setting screen 130 as shown in FIG. 3B. In this importance degree setting screen 130, three setting keys 131 to 133 are arranged for setting a degree of importance of a document to be copied, so that a degree of importance of the document can be selected from “High”, “Intermediate” and “Low”. When the “OK” key 134 is pressed after pressing one setting key 131 (or setting key 132, or 133) among the setting keys 131 to 133, the set content is determined. On the other hand, when the “Cancel” key 135 is pressed, the process of returning to the initial screen 120 is performed without determining the set content.

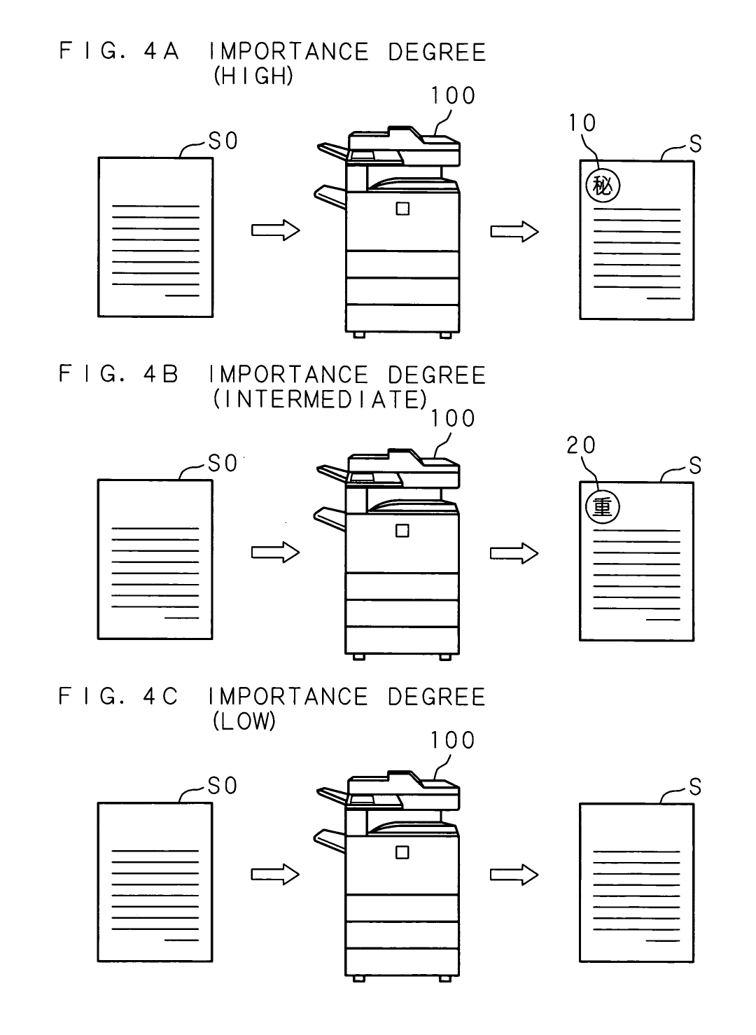

FIGS. 4A to 4C are explanatory views for explaining the relationship between the set importance degrees and specific patterns to be added. When the degree of importance of a document S0 is set “High” in a copying process, that is, when the “OK” key 134 is pressed after pressing the setting key 131 on the above-mentioned importance degree setting screen 130, the digital multi-function machine 100 adds a specific pattern including a Japanese character meaning “secret” written in a circle (hereinafter referred to as a first specific pattern 10) to an image to be outputted and then records the resulting image on paper S (FIG. 4A).

When the degree of importance of the document S0 is set “Intermediate” in a copying process, that is, when the “OK” key 134 is pressed after pressing the setting key 132 on the above-mentioned importance degree setting screen 130, the digital multi-function machine 100 adds a specific pattern including a Japanese character meaning “important” written in a circle (hereinafter referred to as a second specific pattern 20) to an image to be outputted and then records the resulting image on paper S (FIG. 4B).

On the other hand, when the degree of importance of the document S0 is set “Low” in a copying process, that is, when the “OK” key 134 is pressed after pressing the setting key 133 on the above-mentioned importance degree setting screen 130, the digital multi-function machine 100 records the image scanned by the image scanning unit 106 as it is on paper S without adding the specific patterns 10 and 20 (FIG. 4C).

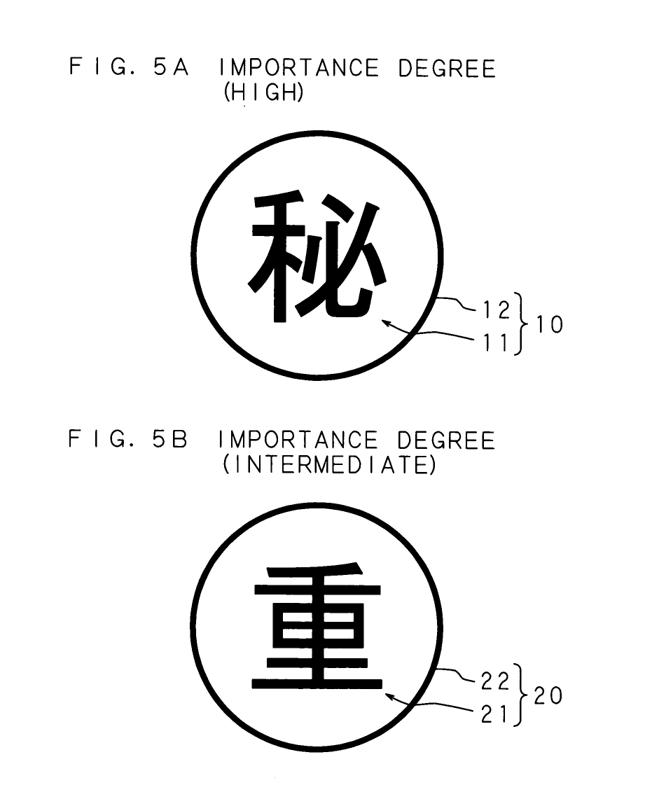

FIGS. 5A and 5B are schematic views showing the structures of specific patterns. A pattern to be added when the degree of importance of a document is set “High” is the first specific pattern 10 shown in FIG. 5A. As the first specific pattern 10, a mark including the Japanese character meaning “secret” written in a circle (the “circled secret” mark) is adopted, and this mark is composed of a character area 11 including the character meaning “secret” and a circular boundary line 12. A pattern to be added when the degree of importance of a document is set “Intermediate” is the second specific pattern 20 shown in FIG. 5B. As the second specific pattern 20, a mark including the character meaning “important” written in a circle (the mark meaning “important”) is adopted, and this mark is composed of a character area 21 including the character meaning “important” and a circular boundary line 22.

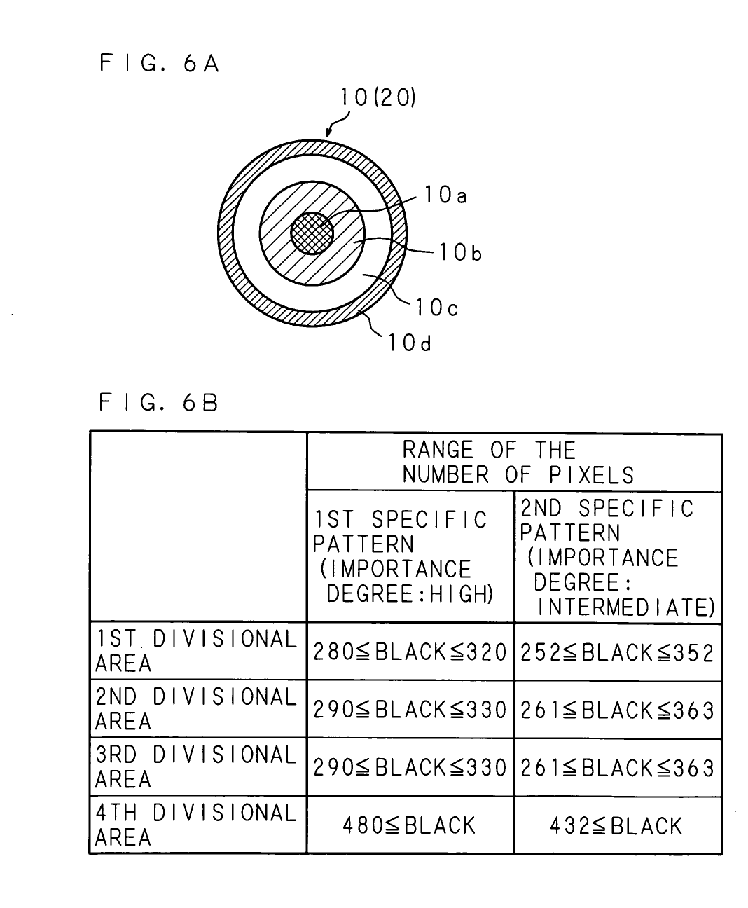

When copying (secondary copying) papers on which these specific patterns 10 and 20 are recorded by the digital multi-function machine 100, a determination is made as to whether or not the specific patterns 10 and 20 are included, based on the distribution of black pixels included in the specific patterns 10 and 20. Therefore, marks including mutually different numbers of pixels are used as the specific patterns 10 and 20. FIGS. 6A and 6B are explanatory views for explaining the distribution of the number of pixels in the specific patterns 10 and 20. In this embodiment, each of the specific patterns 10 and 20 is divided into four areas, and the distribution of the number of pixels is defined. FIG. 6A shows a dividing example. In this example, each of the specific patterns 10 and 20 is concentrically divided so that an area enclosed by a circumference with the smallest radius is a first divisional area 10a, an area enclosed by this circumference and a circumference with the second smallest radius is a second divisional area 10b, an area enclosed by this circumference and a circumference with the third smallest radius is a third divisional area 10c, and an area enclosed by this circumference and the outer circumference is a fourth divisional area 10d.

FIG. 6B shows the distribution of the number of pixels in each of the specific patterns 10 and 20. Specifically, for the first specific pattern 10, a pattern having 280 to 320 black pixels in the first divisional area 10a, 290 to 300 black pixels in the second divisional area 10b, 290 to 300 black pixels in the third divisional area 10c, and 480 or more black pixels in the fourth divisional area 10d is used. Similarly, a pattern having the distribution of the number of pixels shown in FIG. 6B is used for the second specific pattern 20.

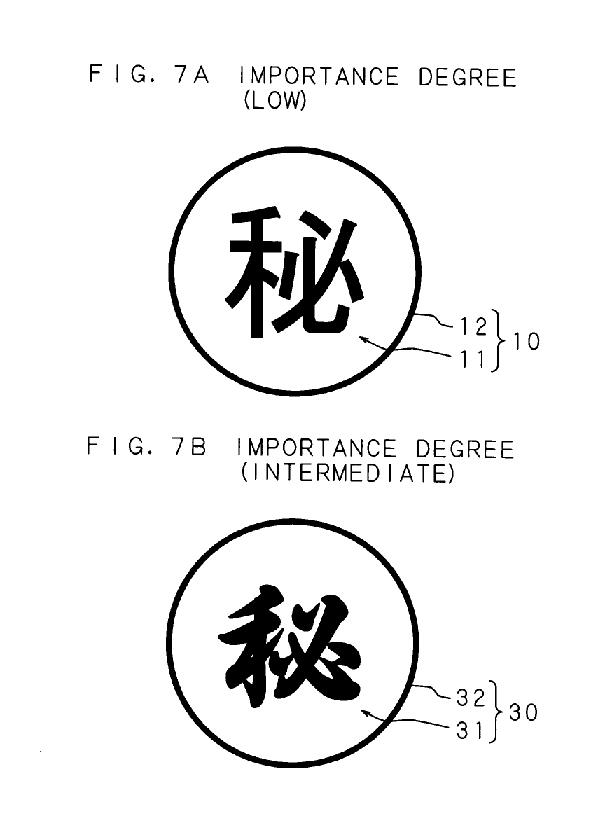

Of course, the specific patterns 10 and 20 are not limited to those shown in FIGS. 5A and 5B. FIGS. 7A and 7B are schematic views showing other structures of specific patterns. A pattern shown in FIG. 7A is the same as the first specific pattern 10 shown in FIG. 5A, but a specific pattern 30 shown in FIG. 7B uses a pattern composed of a circular boundary lien 32 and a character area 31 with different font and letter style. Even when such a combination of specific patterns 10 and 30 is used, they can be detected by hardware as long as they have the distribution of the number of pixels shown in FIG. 6B. Hence, when it is necessary to change a pattern to be detected, a pattern having the pixel distribution shown in FIG. 6B may be created and registered in the memory in the image processing section 108. Further, it may be possible to receive a change in the distribution of pixels through the operating panel 105, and then a pattern to be registered may be changed to match the received image distribution. In this case, a pattern is read from the memory in the image processing section 108, enlargement or reduction of the scanned image is performed, or the font used in the pattern is changed, and then the resulting pattern is reregistered in the memory in the image processing section 108 to complete the change of the pattern.

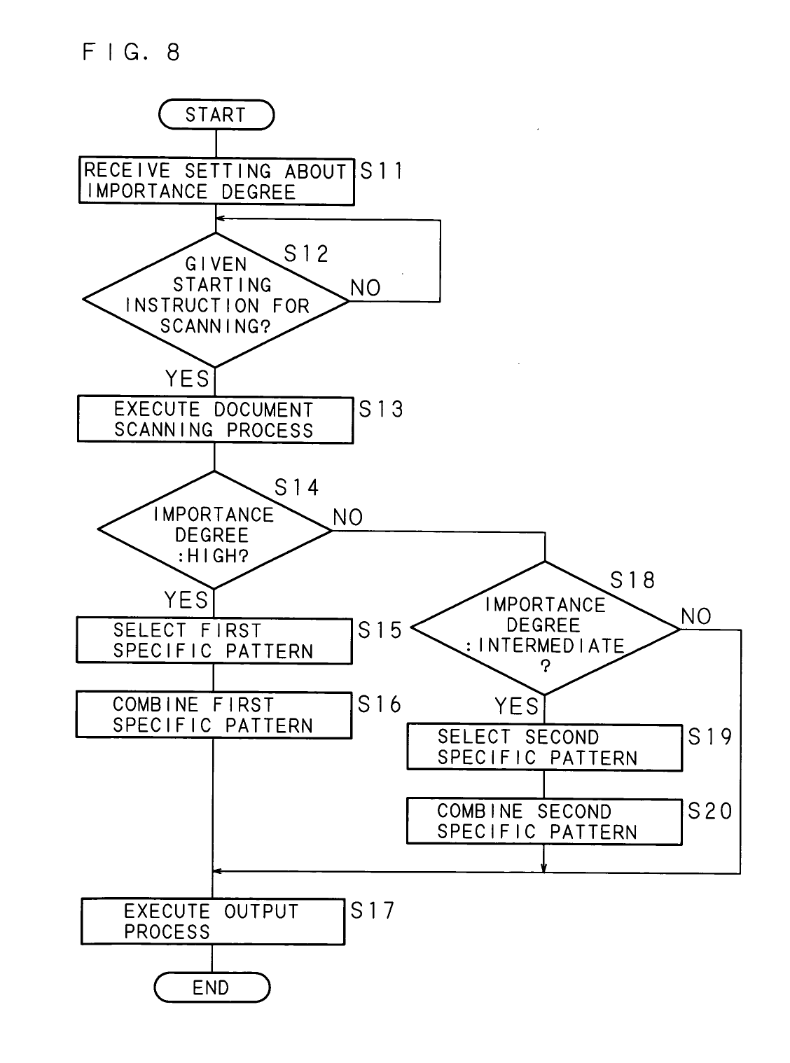

FIG. 8 is a flowchart for explaining the processing steps for recording the specific patterns 10 and 20 on paper. After receiving the setting about the degree of importance of a document to be copied through the operating panel 105 (step S11), the CPU 101 monitors information inputted through the operating section 105a of the operating panel 105 and determines whether or not there is an instruction to start scanning a document (step S12). When a determination is made that there is not an instruction to start scanning (S12: NO), the CPU 101 waits until an instruction to start scanning is given.

When a determination is made that an instruction to scan a document is given (S12: YES), the CPU 101 controls the image scanning unit 106 to execute a document scanning process (step S13). More specifically, the CPU 101 scans an image within a specified range by turning on the light source and acquiring image data in the main scanning direction while moving the light source in the sub-scanning direction and scanning a document in the range. The image data obtained by the image scanning unit 106 is transferred to the image processing section 108 via the image memory 107.

Next, the CPU 101 determines whether or not the degree of importance received in step S11 is high (step S14). When determined to be high (S14: YES), the CPU 101 selects the first specific pattern 10 as a pattern to be combined (step S15). Then, the CPU 101 combines the selected first specific pattern 10 with the image data scanned in step S13 (step S16), and executes the output process by transferring the resulting composite image data to the image recording section 109 (step S17).

On the other hand, when a determination is made that the degree of importance received in step S11 is not high (S14: NO), the CPU 101 determines whether or not the degree of importance received in step S11 is intermediate (Step 18). When the degree of importance is determined to be intermediate (S18: YES), the CPU 101 selects the second specific pattern 20 as a pattern to be combined (step S19). Then, the CPU 101 combines the selected second specific pattern 20 with the image data scanned in step S13 (step S20), and executes the output process by transferring the resulting composite image data to the image recording section 109 (step S17).

On the other hand, when a determination is made that the degree of importance received in step S11 is not intermediate (S18: NO), the CPU 101 executes the output process by transferring the image data held in the image memory 107 as it is to the image recording section 109 (step S17).

The following description will specifically explain the operation for detecting the specific patterns 10 and 20 recorded on documents. FIG. 9 is an explanatory view for explaining the state when scanning a document. As described above, the image scanning unit 106 comprises the CCD line sensor constructed by arranging many CCDs in the main scanning direction, and acquires line data (image data) in the main scanning direction about the paper S placed on the document mounting 106a made of glass. Moreover, the image scanning unit 106 obtains image data on the entire surface or a specified range of the paper S by acquiring line data at a predetermined sampling cycle while scanning the light source in the sub-scanning direction by moving it with a stepping motor (not shown). Note that the example shown in FIG. 9 illustrates the state of the document S, which is an object to be scanned, seen from the lower side of the document mounting 106a, and this paper S is provided with the first specific pattern 10 as one of specific patterns.

In order to detect these specific patterns 10 and 20 from image data inputted through the image scanning unit 106, the image processing section 108 first binarizes the inputted image data. In the inputted image data, although each pixel has 256 gradations for each of RGB colors, the gradations are converted into two gradations of white (pixel value is 1) and black (pixel value is 0). At this time, it may also be possible to perform the process of decreasing the resolution of the image data. For example, when the inputted image data has 600 dpi (dots per inch), it may be possible to decrease the resolution to 200 dpi and perform the subsequent process by using the resulting data.

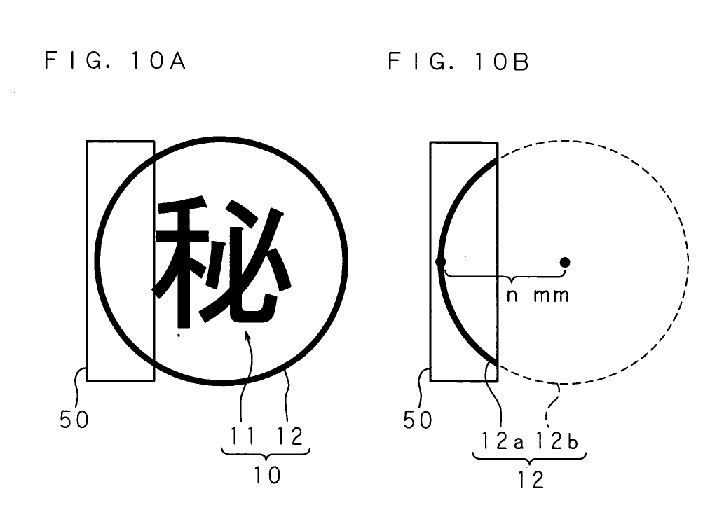

Next, the image processing section 108 detects the boundary line 12 of the first specific pattern 10, or the boundary line 22 of the second specific pattern 20, from the binarized image data. FIGS. 10A and 10B are explanatory views for explaining the contents of processing performed when detecting the boundary lines 12 and 22. In this embodiment, as shown in FIG. 10A, the boundary lines 12 and 22 are detected by using a rectangular detection window 50 with a predetermined size. For example, suppose that the radius of a circle formed by the boundary line 12 of the first specific pattern 10 is n [mm]. When the entire image was scanned by shifting the detection window 50 one dot at a time in the main scanning direction and the sub-scanning direction, when the radius of a curvature appeared in this detection window 50 was n [mm], as shown in FIG. 10B, a determination is made that the boundary line 12 of the first specific pattern 10 was detected, based on an arc 12a in the detection window 50 and a remaining arc 12b. The same process is also performed for the second specific pattern 20.

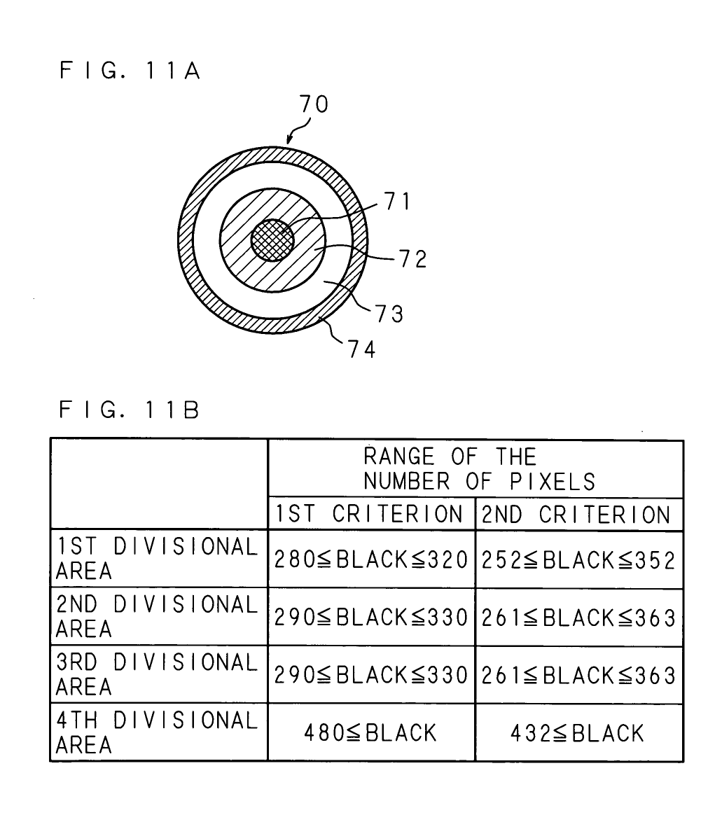

Thus, by estimating the circular boundary line from the detected arc, it is possible to extract an area that may possibly include the first specific pattern 10 or the second specific pattern 20 (hereinafter referred to as the detection area). In order to discriminate the type of an image included in this detection area, the image processing section 108 divides the detection area into four divisional areas, and examines the number of pixels in each divisional area (that is, the distribution of the number of pixels in the detection area). FIGS. 11A and 11B are explanatory views for explaining the relationship between an example of dividing a detection area and the distribution of the number of pixels. FIG. 11A shows a dividing example. In this example, an extracted detection area 70 is concentrically divided so that an area enclosed by a circumference with the smallest radius is a first divisional area 71, an area enclosed by this circumference and a circumference with the second smallest radius is a second divisional area 72, an area enclosed by this circumference and a circumference with the third smallest radius is a third divisional area 73, and an area enclosed by this circumference and the outer circumference is a fourth divisional area 74.

FIG. 11B shows a table defining the range of the number of pixels in each of the divisional areas 71, 72, 73 and 74. According to this table, a determination is made as to whether or not the first specific pattern 10 or the second specific pattern 20 is included. For example, when the number of black pixels in the first divisional area 71 is within a range of 280 to 320, the number of black pixels in the second divisional area 72 is within a range 290 to 330, the number of black pixels in the third divisional area 73 is within a range 290 to 330, and the number of black pixels in the fourth divisional area 74 is 480 or more, that is, when the distribution of black pixels in the detection area 70 satisfies a first criterion, the image is determined to be the first specific pattern 10. Similarly, when the distribution of black pixels in the detection area 70 satisfies a second criterion, the image is determined to be the second specific pattern 20. Note that the table shown in FIG. 11B is pre-stored in the memory (not shown) installed in the image processing section 108, and a calling process or a rewriting process is executed according to an instruction from the CPU 101.

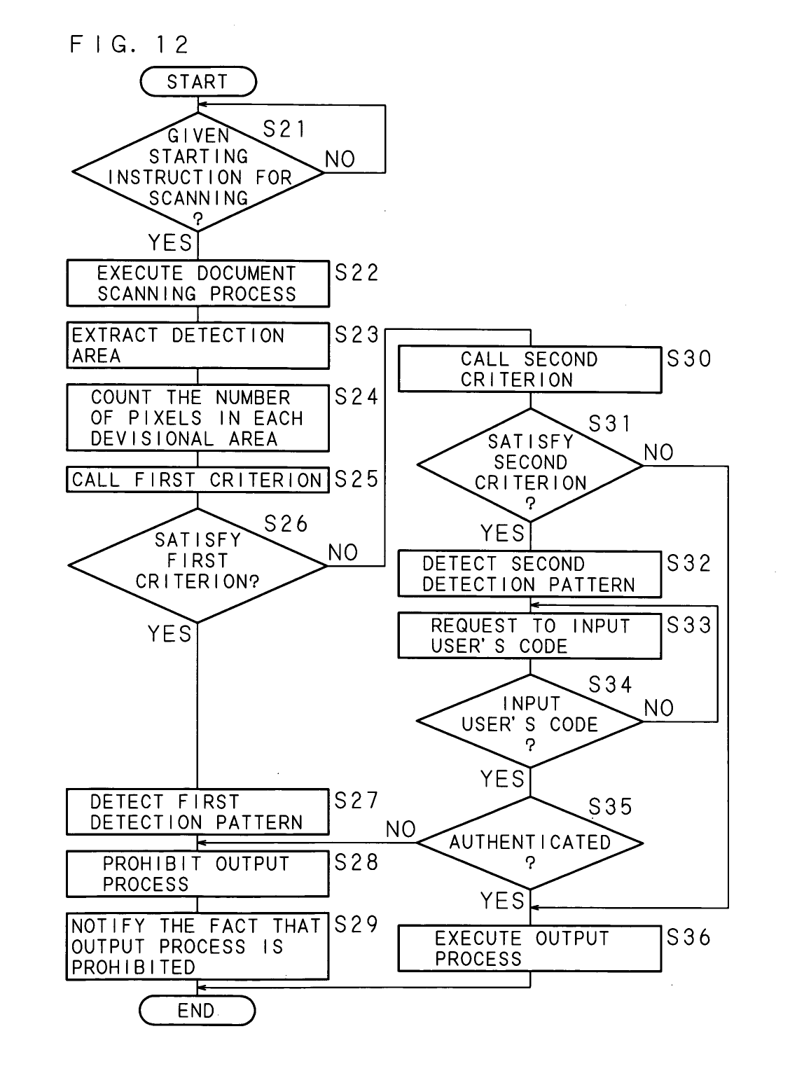

The following description will explain the processing steps executed by the digital multi-function machine 100 when copying a document. FIG. 12 is a flowchart for explaining the processing steps for copying a document. First, the digital multi-function machine 100 monitors information inputted through the operating section 105a of the operating panel 105 and determines whether or not there is an instruction to start scanning a document (step S21). When a determination is made that there is not an instruction to start scanning (S21: NO), the CPU 101 waits until an instruction to start scanning is given.

When a determination is made that an instruction to start scanning a document is given (S21: YES), the CPU 101 controls the image scanning unit 106 to execute the document scanning process (step S22). The image data obtained by the image scanning unit 106 is transferred to the image processing section 108 via the image memory 107.

Next, the CPU 101 controls the image processing section 108 to extract a circular area having a predetermined radius as a detection area by using the above-mentioned technique (step S23). In other words, the image processing section 108 binarizes the image data transferred via the image memory 107, and extracts the circular area as an object to be detected by pattern matching.

The CPU 101 controls the image processing section 108 to divide the extracted detection area into four areas and then count the number of pixels having a pixel value corresponding to black in each divisional area (step S24).

Next, the CPU 101 calls the first criterion pre-stored in the memory in the image processing section 108 (step S25), and determines whether or not the counted number of pixels in each divisional area satisfies the first criterion (step S26). When a determination is made that the first criterion is satisfied (S26: YES), the CPU 101 determines that the first specific pattern 10 has been detected (step S27).

Then, the CPU 101 prohibits the output process (step S28), and gives a notification indicating that the output process is prohibited (step S29). Here, prohibition of the output process is realized by prohibiting a transfer of image data held in the image memory 107 to the image recording section 109. Besides, the notification indicating that the output process is prohibited is given by displaying a massage indicating this on the display section 105b of the operating panel 105.

In step S26, when a determination is made that the first criterion is not satisfied (S26: NO), the CPU 101 calls the second criterion pre-stored in the memory in the image processing section 108 (step S30), and determines whether or not the number of pixels counted in each divisional area satisfies the second criterion (step S31). When a determination is made that the second criterion is satisfied (S31: YES), the CPU 101 determines that the second specific pattern 20 has been detected (step S32).

When the second specific pattern 20 is detected, the CPU 101 requests the user to input the user's code (step S33). Here, the user's code is an authentication code (for example, a four-digit number) allocated to each user, and the authentication code of a person authorized to use the machine is pre-stored in the ROM 103 in the digital multi-function machine 100. Moreover, the request for the input of the user's code is made by displaying a message requesting the input on the display section 105b of the operating panel 105.

The CPU 101 monitors information inputted through the operating section 105a and determines whether or not the user's code has been inputted (step S34). When a determination is made that the user's code has not been inputted (S34: NO), the CPU 101 returns the process to step S33. On the other hand, when a determination is made the user's code has been inputted (S34: YES), the CPU 101 determines whether or not the user can be authenticated by collating the inputted user's code with the user's code stored in the ROM 103 (step S35). When a determination is made that the user cannot be authenticated (S35: NO), the CPU 101 prohibits the output process (S28), and gives a notification indicating that the output process is prohibited (S29). On the other hand, when a determination is made that the user can be authenticated (S35: YES), the CPU 101 transfers image data held in the image memory 107 to the image recording section 109, and executes the output process (step S36).

In step S31, when a determination is made that the second criterion is not satisfied (S31: NO), the CPU 101 transfers the image data held in the image memory 107 to the image recording section 109 and executes the output process (S36).

Note that although this embodiment illustrates a mode for detecting whether or not image data obtained by scanning an image on a document includes the specific pattern 10 or 20, it is of course possible to detect the specific pattern 10 or 20 by the same technique as above for image data developed from print data received by the communication IF 110, and image data obtained by decrypting facsimile data received by facsimile communication IF 111. In this case, a notification to be given in step S29 may be given by transmitting information indicating that the output process is prohibited to the information processor 200 that is the source of the print data, or the facsimile machine 300 that is the source of the facsimile data.

Moreover, in this embodiment, although objects to be detected by the digital multi-function machine 100 are two types of patterns, namely the first detection pattern 10 represented by the “circled secret” mark, and the second detection pattern 20 represented by the mark meaning “important”, it is, of course, not necessary to limit the objects to be detected to these marks. Further, although the patterns to be detected are of two types, it is of course possible to detect three or more types of patterns by setting a range of the number of pixels for three or more types of marks in advance. Besides, in this embodiment, although the boundary line 12 of the first detection pattern 10 and the boundary line 22 of the second detection pattern 20 are circular, they are not necessarily circular, and, needless to say, it is also possible to detect polygons such as a rectangle and a triangle, or any predetermined shapes.

Further, in this embodiment, when the first detection pattern 10 is detected, the output process is prohibited, and, when the second detection pattern 20 is detected, the output process is permitted after authenticating the user. However, instead of prohibiting the output process, it may be possible to perform the output process after combining noise, or a message indicating that copying is prohibited, with an image to be outputted.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image recording apparatus comprising:
a storage section for storing a plurality of pieces of image data composed of a plurality of pixels and different in a ratio of pixels having a predetermined value;
a controller capable of performing operations of:
receiving image data;
selecting image data to be combined with the received image data from the image data stored in said storage section; and
combining the selected image data with the received image data; and
a recording section for recording an image on a sheet, based on the resulting composite image data.

2. The image recording apparatus according to claim 1, wherein said controller is further capable of performing operations of:
receiving information about the ratio of the pixels;
changing the image data stored in said storage section, based on the received information; and
storing the changed image data in said storage section.

3. The image recording apparatus according to claim 1,
wherein said controller is further capable of performing an operation of receiving information about importance of the received image data, and
wherein image data to be combined is selected based on the received information.

4. The image recording apparatus according to claim 1,
wherein said controller is further capable of performing an operation of receiving information about confidentiality of the received image data, and
wherein image data to be combined is selected based on the received information.

5. An image recording apparatus according to claim 1, further comprising a scanning section for scanning an image recorded on a sheet,
wherein said controller is further capable of performing operations of
extracting an area from the image scanned by said scanning section;
calculating a ratio of pixels having a predetermined pixel value in pixels constituting the extracted area; and
detecting a type of an image included in the area, based on the calculated ratio of pixels.

6. The image recording apparatus according to claim 5, further comprising a table that defines a relation between a type of an image to be detected and the ratio of pixels having the pixel value in the area including the image,
wherein the type of the image is detected by referring to the relation defined in said table.

7. The image recording apparatus according to claim 5, wherein said controller is further capable of performing operations of:
determining whether or not the detected type of the image is a predetermined type; and
prohibiting recording of the image scanned by said scanning section on a sheet when a determination is made that the detected type is the predetermined type.

8. The image recording apparatus according to claim 5, wherein said controller is further capable of performing operations of:
determining whether or not the detected type of the image is a predetermined type;
receiving information about a user when a determination is made that the detected type is the predetermined type;
authenticating a user based on the received information; and
prohibiting recording of the image scanned by said scanning section on a sheet when a determination is made that a user cannot be authenticated.

9. An image recording apparatus comprising:
storage means for storing a plurality of pieces of image data composed of a plurality of pixels and different in a ratio of pixels having a predetermined pixel value;
means for receiving image data;
means for selecting image data to be combined with the received image data from the image data stored in said storage means;
means for combining the selected image data with the received image data; and
means for recording an image on a sheet, based on the resulting composite image data.

10. The image recording apparatus according to claim 9, further comprising:
means for receiving information about the ratio of the pixels;
means for changing the image data stored in said storage means, based on the received information; and
means for storing the changed image data in said storage means.

11. The image recording apparatus according to claim 9, further comprising means for receiving information about importance of the received image data,
wherein image data to be combined is selected based on the received information.

12. The image recording apparatus according to claim 9, further comprising means for receiving information about confidentiality of the received image data,
wherein image data to be combined is selected based on the received information.

13. An image recording apparatus according to claim 9, further comprising:
scan means for scanning an image recorded on a sheet,
means for extracting an area from the image scanned by said scan means;
means for calculating a ratio of pixels having a predetermined pixel value in pixels constituting the extracted area; and
means for detecting a type of an image included in the area, based on the calculated ratio of pixels.

14. The image recording apparatus according to claim 13, further comprising a table that defines a relation between a type of an image to be detected and the ratio of pixels having the pixel value in the area including the image,
wherein the type of the image is detected by referring to the relation defined in said table.

15. The image recording apparatus according to claim 13, further comprising:
means for determining whether or not the detected type of the image is a predetermined type; and
means for prohibiting recording of the image scanned by said scan means on a sheet when a determination is made that the detected type is the predetermined type.

16. The image recording apparatus according to claim 13, further comprising:
means for determining whether or not the detected type of the image is a predetermined type;
means for receiving information about a user when a determination is made that the detected type is the predetermined type;
means for authenticating a user based on the received information; and
means for prohibiting recording of the image scanned by said scan means on a sheet when a determination is made that a user cannot be authenticated.
